(19) United States
(12) Patent Application Publication
(10) Pub. No.: US 2011/0053511 A1
(43) Pub. Date: Mar. 3, 2011

(54) CONNECTOR FOR CONNECTING A RENDERING DEVICE TO AT LEAST ONE OUTPUT DEVICE AND METHOD FOR MANAGING OUTPUT

(76) Inventor: Jeroen De Weerd, Maastricht (NL)

(21) Appl. No.: 12/735,152

(22) PCT Filed: Dec. 17, 2007
(86) PCT No.: PCT/EP2007/064098

§ 371 Date: Nov. 12, 2010

(51) Int. Cl. H04B 7/24; H04B 7/00

(52) U.S. Cl. 455/41.3; 455/39

(57) ABSTRACT

The present invention relates to a connector for connecting a rendering device (3) to at least one output device (2). The connector is characterized in that it has at least two output interfaces (13, 105), wherein one output interface (105) is a signal transmitter for transmitting signals via radio frequencies. Furthermore a method for managing output from at least one rendering and/or a communication device (3, 4), wherein a connector (1) for connecting the rendering and/or communication device (3, 4) to at least one output device (2) is interposed between the rendering device and/or communication device (3, 4) and the at least one output device (2, 6). The method is characterized in that the connector (1) receives audio and/or video signals from at least one rendering or communication device (3, 4) and transmits the received signal to one of at least two output interfaces (13, 105) of the connector (1) depending on the state of the output interfaces (13, 105) and/or on the nature of the received signals.

The present invention relates to a connector for connecting a rendering device to at least one output device. The invention further relates to a method for managing output.

Mobile phones have become a preferred solution to ensure that a user can be reached regardless of his current location. In addition, mobile digital music player and other mobile rendering devices have become known. The user can listen to the audio signal of the mobile phone and to that of a digital music player via respective headsets.

It has furthermore been suggested to transmit the output of a mobile phone via the headset to a radio receiver. Such a transmission via the headset is for example described in WO 2007/102651 A1. Herein the headset communicates to the mobile phone via a Bluetooth connection and can transmit the thus received audio signals via FM (frequency modulation) to an FM receiver. One disadvantage of this solution is that the headset is the transmission device for the respective audio signal to the FM receiver and thus has to be equipped with respective functionalities. As the headset has to be worn at the or close to the ear, buttons or displays which may inform the user of current settings, will not be visible to the user. In addition, the usage of standard headsets is not possible. Finally, with the solution of the prior art, the headset has to always be in communication with the mobile phone in order to be alerted of an incoming call. When using the headset to listen to audio signals from a digital music player, the user will not be able to use the headset for communication via the mobile phone.

In addition, JP 11154994A describes a notification device which can be attached to a rendering device to notify a user, who is listening to content being rendered from the rendering device via wired head phones, of an incoming call on his mobile phone. The notification device will either interrupt or mix the rendered signal with a notification signal informing the user about the call. One drawback of this solution is that the user will have to take of his head phones off in order to be able to answer the incoming call on his mobile phone. Furthermore, the output of the rendering device according to the prior art document will always be transmitted to the headset, thus limiting the flexibility of the user.

The problem to be solved by the present invention is thus to overcome these drawbacks of the prior art solutions and in particular to provide a solution for easy and flexible connection of at least a rendering device to at least one output device.

The invention is based on the finding that the problem can be solved by providing means to manage the connection of a rendering device to an output device as well as to other devices within the connection itself.

According to a first aspect, the present invention relates to a connector for connecting a rendering device to at least one output device. The connector is characterized in that it has at least two output interfaces, wherein one output interface is a signal transmitter for transmitting signals via radio frequencies.

The rendering device may be any device capable of providing a signal to be output via an output device. In particular, the rendering device is a device for rendering audio content and emitting audio signals to an output device. The rendering device may be a device for rendering media, such as a stereo system, a TV, a CD-Player, a DVD player. Preferably, the device is portable such as an MP3-player or Ipod®. The rendering device may also be a device connectable to a communication network. In this case, the rendering device may for example be a mobile phone.

The output device can be a headset, earphones or a radio receiver for audio output. The output device may, however, also be a display screen or other output device for video output. At least one of the output devices is preferably connected to the rendering device in a wired fashion, i.e. by a cable which may be part of the output device or could be connected thereto. At least one of the output devices has a wireless connection to the connector via radio frequencies. This output device may be an FM radio receiver. At least one of the output devices may also be connected to the connector via other wireless connections.

By providing a connector which is separate to the rendering device and to the output device, the transmission of signals can be carried out in a flexible fashion and can particularly be adjusted to the current needs of the user. The provision of two output interfaces allows the manual or automatic selection of the preferred output device connected to the respective output interface for the current needs. An output interface according to the present invention is a unit within the connector for connecting to a separate output device via a wire connection or wirelessly. The output interface may be a cable firmly connected to the connector or a wireless, in particular FM transmitter.

The connection to the rendering device from the connector is preferably a wired connection. The connector can be connected to standard output devices, i.e. even to output devices which are not specifically designed for a wireless communication, e.g. standard earplug headsets of a digital music player.

According to a preferred embodiment, the connector comprises at least one communication unit for communicating with at least one wireless communication device wirelessly, in particular a Bluetooth unit. The wireless communication device may be the rendering device to which the output device is to be connected. In this case, the connection from the rendering device to the connector is realized wirelessly. According to the invention, the wireless communication device may, however, preferably be a device different from the rendering device. In this case, the connection from the rendering device to the connector may be a wired connection or the connector may be integrated in the rendering device. The communication device with which the communication unit can communicate is preferably a mobile phone.

By providing a communication unit for communicating with a communication device, such as a mobile phone in addition to the connection which is established with the rendering device, also the input which eventually is to be output to one of the several output interfaces can be changed according to the current needs of the user. Thereby the flexibility will be further increased.

In a preferred embodiment, the connector comprises at least one switching unit for switching from a first output interface to a second output interface. The switching unit is preferably a unit within the connector which is activated automatically. It may, however, also comprise activation means for a user to switch to the desired output interface.

The connector may comprise a surveillance unit for surveying the availability of an output device at the output interface. The surveillance unit may be a monitoring unit monitoring several output interfaces for availability of output devices. It is, however, also possible that part of the surveillance unit is provided at the respective output interfaces and indicates connection of an output device, such as the detection of a plug of the device in a socket, thereby setting the availability of the output interface to ON. This change in status can be detected by a central surveillance unit. The surveillance unit may detect the connection to an output device at the connector or the availability of an output device remote to the connector, i.e. a wireless connection. By monitoring the availability of the respective output devices, the connector may automatically choose an output interface according to the availability of an output device. Alternatively, the connector may indicate, e.g. display the availability to the user. In the latter case, the user can select his preferred output device.

Preferably, the surveillance unit is connected to the switching unit. By providing this connection, an automatic change from one output interface to another can be accomplished dependent on the availability of output devices at the respective output interfaces.

According to one embodiment, the switching unit is connected to a determination unit for determining the input source of signals to be routed through the switching unit. By providing such a determination unit, the switching to one of the output interfaces, can be based on the nature of the signal to be output. For example, audio signals received from a digital music player may be transmitted to an output device where more than one person can listen to the output, such as a radio receiver. Audio signals from a mobile phone in contrast may be transmitted to an output device such as a headset to only allow the user to listen to the audio. The setting of the respective output interface for different audio signals can be set within the connector by the user or can be preset at the point of manufacturing of the connector.

According to one embodiment, the connector comprises at least one detection unit for detecting at least one external signal. The external signal is a signal different from video or audio signals from the rendering device or a communication device and also different from control signals or communication signals of units of the connector. The external signal may be a signal originating from a device which is different to the rendering device and the at least one output device. Preferably, the external signal originates from the wireless communication device which can communicate with the communication unit of the connector. The external signal may preferably be an electromagnetic wave signal in the frequency range of for example 900 MHz.

The detection unit detects external signals without necessitating a predetermined connection to the device from which the external signal originates to be established beforehand. One possible embodiment of the detection unit may comprise a diode.

By providing such a detection unit, the connector may flexibly be connected to a communication device upon availability of the respective communication device or upon a specific state of the communication device, such as an incoming call arriving at the communication device or a call being initiated from the communication device.

The detection unit may be set to and/or can be adjusted to detect signals in the frequency range of control channels of a mobile communication standard, in particular GSM, UMTS, EDGE and/or any 3G or 4G-standard. The frequency range may be for example 890-915 MHz and/or 935-960 MHz for a GSM standard network. By monitoring signals within such frequency ranges, signals on control channels can be detected. Hence, the connector will be able to detect signals such as the call setup signal, which is generated by a mobile phone, when a call comes in. The connector may be set to only detect a specific sequence of signals in this frequency range representative of for example the call setup signal. In addition or alternatively, the detection may be set to only detect signals of specific signal strength. Thereby signals originating form a mobile phone close to the user will be detected, whereas other signals within this frequency range originating from other mobile phones will be ignored.

Preferably, the detection unit is connected to the communication unit for managing the communication unit. By connecting the detection unit of the connector to the communication unit of the connector, the detection unit can control at least part of the functionality of the communication unit. In particular, the establishing of a wireless communication connection of the communication unit with a communication device can be initiated by activating the communication unit from the detection unit. Thereby, a communication connection between the connector and the wireless communication device can be managed according to specific events which are detected by the detection unit. For example, a communication connection may be established upon detection of an incoming call. Thereby, at least one of the output devices can be used for communication to a third party via the communication device. The appropriate output device may be selected based on the user's preferences. For example a user may prefer to receive phone calls via a headset rather than an output device such as a radio where other people can also listen. One further advantage of connecting the detection unit to the communication unit is that the communication unit, especially when being realized as a Bluetooth unit and thus consuming considerable amount of energy, will only be activated when needed. Thereby, the power consumption of the connector can be minimized.

The connector preferably furthermore comprises at least one interruption unit for managing the connection of the rendering device to the output device. Especially in cases, where the rendering device is a different device than the communication device, the interruption unit may interrupt the transmission of signals from the rendering device to the output devices and may in particular transmit signals received via the communication unit of the connector to at least one of the output devices. Thereby, the input signal to be transmitted to and to be output at one of the output devices can be set to be a signal received from the communication device instead of signals received from the rendering device. The interruption unit may also previous to transmission of the signal from the communication unit, input a ring tone or other alert to inform the user of an incoming call. The interruption unit may include an interruption element such as a switch or a relay, e.g. a solid-state relay. The interruption element is preferably reversible so that the connection from the rendering device to the output device may be re-established once the user has been informed on for example the incoming call and the call is terminated or has been rejected.

The interruption unit may comprise means for inputting a preset audio signal into the connection from the connector to the output device. The means for inputting the preset audio signal may include a storage unit, where the preset audio signal is being stored. The interruption element used to interrupt the connection between the rendering device and the output device may also be used to establish a connection to the storage device. In this case the interruption element is preferably a switch. By inputting a preset audio signal for example a ring tone can be fed to the output device. This is advantageous in that the user will be able to identify the reason for the interruption of audio output from the rendering device. In particular, if the interruption unit only disconnects the transmission of audio signals from the rendering device to the currently used output device for a short period of time, the user may mistake the interruption to be part of the audio signal of the rendering device, e.g. a pause between songs.

The interruption unit may be connected to the detection unit. In this case, the signal transmission from the rendering device to the output devices may be interrupted once a preset signal or a signal sequence is detected by the detection unit. Alternatively or additionally, the communication unit may be connected to the interruption unit. This connection allows for an interruption of the transmission of signals from the rendering device to the selected output device, once a communication connection with a communication device has been set up. In such a communication connection, the existence of an incoming call at the communication device can be verified. The connection of the communication unit to the interruption unit has the further advantage that signals received at the communication unit, in particular audio signals, can easily be provided to the interruption unit to be transmitted to the appropriate output device instead of signals from the rendering device.

The communication unit of the connector is preferably a personal area network communication unit, in particular a Bluetooth unit. This unit allows for reliable and easy connection between the connector and the communication device without necessitating a network such as a cellular network to be present.

The connector may comprise an adjustment unit for adjusting the detection unit, in particular for adjusting the settings of the detection unit. The adjustment unit is preferably laid out to adjust the sensitivity of the detection unit. The adjustment unit may be accessed by the user and the respective settings may thus be set by the user. For this purpose, the connector preferably comprises input means such as an adjustment button or knob.

By providing the possibility to adjust the sensitivity of the detection unit or other settings such as settings of a filter within the detection unit, it will be possible to limit the detected signals to signals of relevance for the user. If the signals to be detected originate from the mobile phone of the user, it can be assumed that the mobile phone will be close to the connector and the sensitivity can thus be set to be low. Thereby, for example only signals having signal strength above a preset threshold value will be detected. This means that only signals from devices close to the connector will then be detected by the detection unit and will initiate the subsequent processes within the connector such as the establishment of a communication connection to the communication device. The adjustment of the detection unit and particularly of the sensitivity of the detection unit is helpful, as the surrounding conditions of the connector, i.e. the environment where the user is currently using the rendering device may change. In crowded places where a lot of communication devices are present, such as in public transportation, the sensitivity of the detection unit should be set to low, so that only external signals originating from the communication device closest to the user will be detected. It should be noted that dependent on the lay-out of the detection unit and in particular the sensors used, it is also possible that a setting High, instead of the setting Low, may indicate that only signals from communication devices nearby will be detected.

The connector may further comprise display means for displaying the settings of the detection unit. For displaying the sensitivity of the detection unit, for example, LED's may be used and the number of LED's illuminated indicates the level of sensitivity. In particular for connectors having an adjustment unit for the detection unit, the display of the currently selected setting will be helpful for the user.

According to one embodiment, the connector comprises at least one control unit for controlling the communication with the communication device, in particular for controlling at least part of the functionalities of the communication device. By providing control of the communication device at least partially at the connector, the user does not have to reach for the communication device and can thus respond faster to the present situation such as an incoming call. The control unit therefore preferably comprises at least one input unit for input from the user. The input unit may for example be a button or a switch. The pushing of the button may be received at the control unit as a signal for accepting the incoming call. In this case, the connector may transmit a respective signal via the communication connection to the communication device to establish a communication with the calling party for example via a cellular communication network. Signals subsequently received from the communication device will be forwarded to the connector for forwarding to one of the output devices. Another button or a different activation of the button may be understood by the control unit as a signal for rejecting an incoming call. In that case, the communication device may decline the request signal received via a cellular communication network. Additionally or alternatively, the control unit also controls at least part of the functionalities of the communication unit. In particular, the termination of the communication connection to a communication device may be triggered by using one of the input units, in particular a reject button.

According to one embodiment, the connector comprises a microphone for input of audio signals. By providing a microphone at the connector, it will be possible to not only transmit received signals from the rendering or the communication device to the output devices but also to transmit audio signals from the connector to the communication device.

In a preferred embodiment, the control unit of the connector for controlling at least part of the functionalities of the communication device is connected to the microphone. By providing such a connection, the microphone may be activated once a user accepts an incoming call and may be deactivated if the call is terminated.

Preferably, the connector comprises at least one connecting wire or cable for connecting to a rendering device. By offering a flexible connection between the rendering device and the connector, in particular for embodiments where the connector comprises a microphone, the connector can be moved freely without having to move the rendering device. It will, hence, be possible for the user to place the connector close to his mouth, for example by attaching it via a clip to a jacket or tie.

The connector is preferably a unit separate from the rendering device and from the output devices. By providing a connector which includes the functionalities necessary for managing the transmission of audio signals to the user as a separate entity, the utilization of the connector is extremely flexible. The connector may in particular be used with different output devices and/or rendering devices. Hence, a user will not be forced to replace any of his presently owned rendering devices or output devices, if he wants to be alerted of incoming calls or other events such as an incoming message, wants to receive the output signal at specific output devices and/or wants to use the currently used output device to answer an incoming call. Another advantage of providing a connector which is a separate entity is that the connector can be removed from the connection between the rendering device and the output device. The removal of the connector may be desirable, if the connector cannot be set to a passive state. In that case, the user can remove the connector, if he does not want to be disturbed, while listening to the audio output of the rendering device, e.g. while listening to music.

In order to allow removal of the connector from the connection between the rendering device and the output device, the connector is equipped with connector means, in particular plugs and sockets, that can receive the respective connector means from the rendering device and the output device. Preferably, the connector means, i.e. receiving means and insertion means are designed to be complementary to standard plugs and sockets provided on commercial output devices and rendering devices. By providing standard receiving and insertion means, the connector can be used with different devices without necessitating amendment to the connector or the devices. For reasons of simplicity the receiving means will be referred to hereinafter as socket.

The connector may be designed according to different standards. Hence, the present invention also encompasses connectors which are provided with for example two plugs and do not comprise a socket. Such an embodiment of the connector may be used with an output device and a rendering device according to a standard where both devices have sockets.

The power supply for the connector may be a power source, such as a battery within the connector. It is, however, also possible that the connector derives the necessary power from the rendering device. If the output device is equipped with a power supply and is connected to the connector via a cable, the connector may also obtain the power from this device.

According to a further aspect of the invention, the problem is solved by a method for managing output from at least one rendering and/or a communication device, wherein a connector for connecting the rendering and/or communication device to at least one output device is interposed between the rendering device and/or communication device and the at least one output device. The method is characterized in that the connector receives audio and/or video signals from at least one rendering or communication device and transmits the received signal to one of at least two output interfaces of the connector depending on the state of the output interfaces and/or on the nature of the received signals.

The state of the output interface reflects the availability of an output device at the output interface. The nature of the received signals is preferably the origin of the signals, i.e. an indication of the rendering device or the communication device from which the signals have been received. By routing the received signals within the connector to the appropriate output interface, the flexibility of the user in terms of output devices is increased. Also the current needs of the user can be observed by this routing of the signals.

In a preferred embodiment, the connector intercepts transmission to an output interface upon detection of availability of an output device at a different output interface. This ensures that the signal is always transmitted to the output interface which is most appropriate at the present point in time. If a radio receiver had been used as an output device, i.e. the signals had been routed within the connector to an FM transmitter, due to the absence of a wired headset at the connector the transmission may be redirected to the wired headset once it is plugged in.

According to one embodiment, at least one output interface of the connector is an interface for transmission via radio frequencies and at least one output interface of the connector is an interface for transmission via a wired connection, wherein the transmission via the wired connection is given preference over the transmission via radio frequencies. By prioritizing the output to an output device which is connected to the connector via a cable, the transmission of signals may automatically be switched, once the user inserts a plug into a socket at the connector.

The connector according to one embodiment identifies the origin of the received signals and transmits the signals to a predetermined output interface. The identification of the origin may be realized by a circuit included in the connector where connections to specific input devices are connected to specific output interfaces.

According to a preferred embodiment, upon detection of a specific external signal which was detected wirelessly the connector activates a communication unit of the connector for communication with the communication device.

By only activating a communication unit of the connector upon detection of a specific signal, the power consumption can be minimized, as a permanent connection with the communication device is not necessary. The communication unit of the connector does in particular not have to monitor signals on a connection with the communication device.

The external signal is preferably a signal on a control channel of a mobile communication network standard, in particular GSM, UMTS, EDGE and/or any 3G or 4G-standard. The frequency range may be for example 890-915 MHz and/or 935-960 MHz for a GSM standard network. By detecting signals within such frequency ranges, signals on control channels can be detected. Hence, the connector will be able to detect signals such as the call setup signal, which is generated by a mobile phone, when a call comes in or a call is initiated. The detection unit may be set to detect a sequence of signals. The sequence of signals may be the call setup signal of a mobile phone, when a call comes in, the ring tone of a mobile phone or a tone issued by the mobile phone, when an SMS is received or is to be received. By not only monitoring individual signals in the surrounding of the connector, the reliability of the relevance of the detected external signals can be increased.

The detection unit may be set to only detect a preset signal or a preset sequence of signals. It is, however, also possible that the detection unit detects all external signals, e.g. within a preset frequency range, and to select the signal or sequence of signals which should be used for further processing in the connector.

The connector may be set to only detect a specific sequence of signals in this frequency range representative of for example the call setup signal. In addition or alternatively, the detection may be set to or adjusted to only detect signals of specific signal strength. Thereby, signals originating form a mobile phone close to the user will be detected, whereas other signals within this frequency range originating from other mobile phones will be ignored.

The external signal may also be a ring tone emitted by the communication device. In this case the detection unit of the connector is set to detect a sequence of audio signals predefined by the ring tone selected by the user. The usage of the ring tone of a communication device as an external signal is, however, less preferred, as the ringtone might be difficult to detect on noisy environments and may not be unique to the user.

One advantage of using an external signal which is detected wirelessly at the connector for activating the communication unit is that no user input is necessary. The manual activation of a communication unit would require the user being aware of an incoming call, which is not the case, if the user for example is listening to music and can thus not hear a ring tone emitted by the communication device.

According to one embodiment, the communication unit upon activation by the detection unit establishes a communication connection, preferably a Bluetooth connection, to the communication device. This communication connection can then serve for transmission of audio signals to and from the communication device and can also serve for transmission of control signals. In particular a control signal for determining the status of the communication connection can be transmitted. The status of communication may for example be “receiving incoming call” or “idle”. By signalling the respective control signals, the status of the communication unit may be used for further processing in the connector. In particular, specific units of the connector may be activated only if a required status of the communication device is detected.

According to one embodiment, the external signals are detected at the connector according to adjustable parameters of the detection unit. The adjustable parameters may be the signal strength, the signal duration and/or signal sequence. These parameters can be set by the user at the connector, for example via adjustment buttons. Alternatively, at least part of the parameters may be preset within the connector during manufacturing.

Preferably, a microphone at the connector is activated at the connector upon establishing a communication connection with the communication device. The microphone may be activated immediately upon establishing of the communication connection. In this case, the microphone may be controlled by the communication unit of the connector. Alternatively or additionally, the microphone may be activated by user input for initiating transmission of audio signals via the communication connection. The user input may be the pushing of a button at the connector for accepting a call that is coming in at the communication device.

The transmission of signals from a rendering device to an output device is interrupted upon detection of the external signal at the connector. The interruption may be triggered immediately after the specific external signal has been detected. Alternatively the interruption of the transmission may be postponed until a communication connection with the communication device has been set up and possibly until the status of the communication device has been confirmed to be receiving an incoming call.

Once the transmission of signals from the rendering device to the output device is interrupted within the connector, signals received from the communication device via the communication connection at the connector are transmitted to one of the output devices instead. The signals transmitted to one of the output devices preferably only include audio signals. Hence, control signals which may be exchanged between the communication device and the connector will not be transmitted to the output device.

The method according to the present invention is preferably carried out with the inventive connector.

Advantages and features described with respect to the connector also apply to the method accordingly and vice versa.

The invention will now be described again with reference to the enclosed figures, wherein:

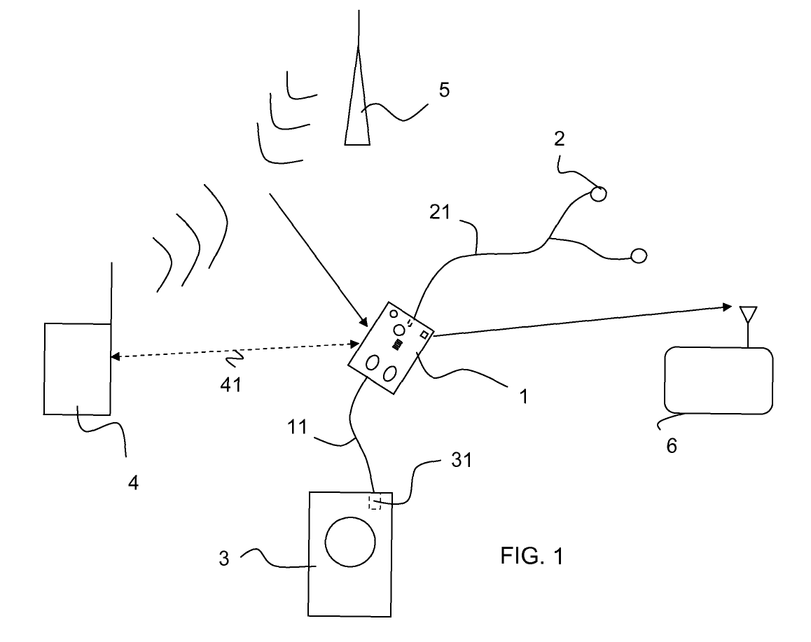

FIG. 1 shows a schematic view of a connector according to the present invention, in a connected state;

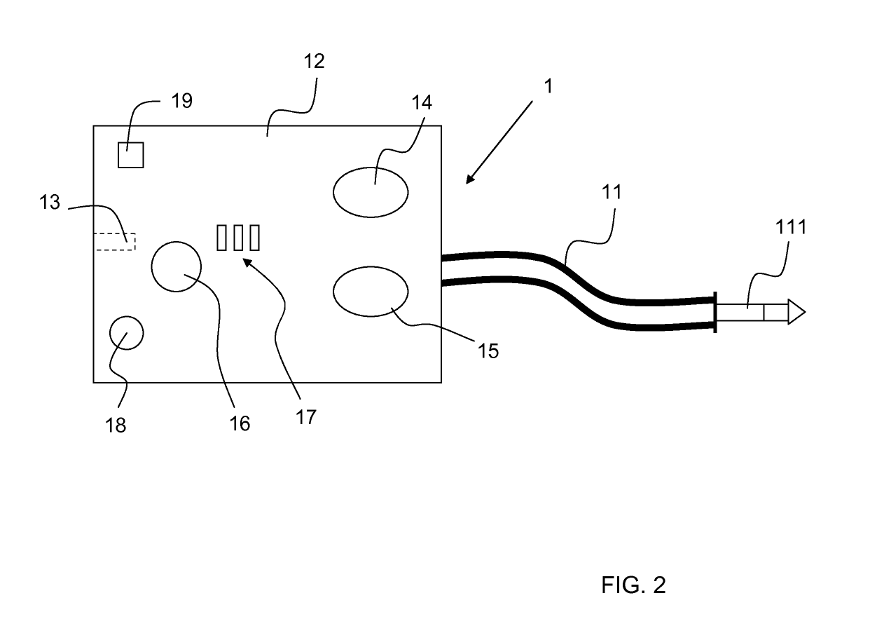

FIG. 2 shows a schematic view of an embodiment of the connector according to the invention; and

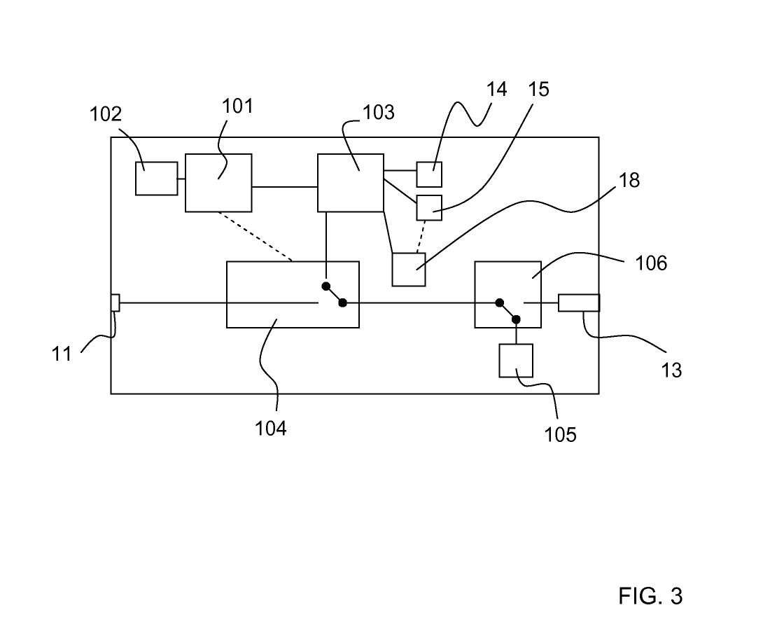

FIG. 3: shows a schematic block diagram of an embodiment of the connector according to the present invention.

In FIG. 1 a connector 1 is connected to an output device 2 depicted as a headset 2. The connector 1 is further connected to a digital music player 3. The connector 1 can also communicate with a mobile phone 4, which is connected to a cellular communication network which is represented in FIG. 1 by a base station 5. In addition the connector 1 can communicate with an FM receiver 6, which may be a radio set. The headset 2 and the FM receiver 6 are referred to as output devices.

The connector 1 is connected to the music player 3 via a cable 11 firmly attached to the connector 1. The cable 11 is plugged into the music player 3. The connection to the headset 2 is established via cable 21 of the headset 2, which is plugged into the connector 1. The mobile phone 4 exchanges signals with the base station 5 of the mobile communication network. The signalling between the mobile phone 4 and the base station 5 is schematically indicated in FIG. 1. Part of this signalling may be detected by connector 1, as is indicated in FIG. 1 by the dashed arrow and will be described in more detail with reference to FIGS. 2 and 3. In addition, the mobile phone 4 may exchange signals with the connector 1 via a communication connection 41, which is preferably a Bluetooth connection. The connector 1 can furthermore transmit signals to the FM receiver 6.

One embodiment of the connector 1 is shown in FIG. 2. The connector 1 has a cable 11 connected to a casing 12. At the loose end of the cable 11, i.e. at the end where the cable 11 is not attached to the casing 12, a plug 111 is provided. This plug 111 can be inserted in a respective receiving means or socket 31 of the music player 3. The socket 31 is schematically shown in FIG. 1. At the side of the casing 12 opposite to the cable 11, a receiving means or socket 13 is provided at the connector 1. This socket 13 can be used to insert a plug (not shown) from the cable 21 of the headset 2. At the upper side of the casing 12 two buttons 14, 15 for controlling the connection to the mobile phone 4 are provided. Button 14 may for example be a reject button for rejecting incoming calls and button 15 may be an accept button for accepting incoming calls. A button or knob 16 is provided for adjusting settings of the connector 1. The settings may be displayed at the display means 17, which are depicted as three LED's. Furthermore a microphone 18 is provided at the connector 1. Finally, in embodiment shown in FIG. 2, a display or indicator 19 for indication of a connection status of the connector 1 to the mobile phone 4 is provided at the casing 12.

Some of the units included in the connector 1 are schematically shown in FIG. 3. A detection unit 101 is connected to an adjustment unit 102. The adjustment unit 102 may be controlled by the adjustment button or knob 16. A communication unit 103 for communication with the mobile phone 4 is connected to the detection unit 101. Also buttons 14, 15 as well as the microphone 18 are connected to the communication unit 103. Buttons 14 and 15 are also referred to as a control unit. The connector 1 further comprises an FM transmitter 105 for transmitting signals via radio frequencies to the FM receiver 6. Between the cable 11 for connecting the connector 1 to the music player 3 and the socket 13 for receiving a plug from the cable 21 of the headset, the FM transmitter 105 an interruption unit 104 and a switching unit 106 are interposed.

The socket 13 and the FM transmitter 105 are referred to as output interfaces for outputting signals from the connector 1 to output devices such as a headset 2 or an FM receiver 6.

The interruption unit 104 can interrupt transmission of signals from the cable 11 to the socket 13 or the FM transmitter 105. In addition, the interruption unit 104 can connect the socket 13 or the FM transmitter 105 to the communication unit 103 for transmission of signals from the mobile phone 4 to the headset 2 or the FM receiver 6. As shown in FIG. 3 the interruption unit 104 can be activated by the communication unit 103 and/or by the detection unit 101. The switching unit 106 can switch the connection between the cable 11 or the communication unit 103 and the socket 13 to a connection between the cable 11 or the communication unit 103 and the FM transmitter 105

The functioning of the connector 1 in the embodiment as shown in the Figures will now be explained in detail. If a user plugs in the connector 1 into the music player 3, and has a cable 21 of the headsets 2 plugged into the socket 13 of the connector, he will be able to listen to music from the music player 3 via his headset 2. In this situation, the interruption unit 104 will be in a state to transmit all signals received from the music player 3 via cable 11 to the cable 21, plugged into socket 13. If he unplugs the cable 21 of the headset 2 from the connector 1, switching unit 106 will switch to the FM transmitter 105 and the signals from the music player 3 will be transmitted and output at the FM receiver 6. The FM receiver 6 may be for example a radio set or a car radio.

If a phone call is to be established with the mobile phone 4, the base station 5 will emit signals to the mobile phone 4. The mobile phone 4 may, upon receipt of the signal respond by sending its identifying information to the base station 5, along with a message confirming that it received the page, via a control channel. At that point voice channels for conducting the phone call will be assigned.

Depending on the network standard, the frequency used for signalling between the mobile phone 4 and the base station 5 is different. In a GSM network the uplink signalling from the mobile phone 4 to the base station 5 will for example be carried on in a frequency range or channel of 890-915 MHz and the downlink signalling from the base station 5 to the mobile phone 4 will be carried out in a frequency range or channel of 935-960 MHz. Within these frequency channels logical channels are established. For example control channels are used. These control channels will only carry cellular system data. Via these channels for example the signalling for call setup will be conducted.

The signals emitted from the mobile phone 4 to the base station 5 can be detected by the detection unit 101 of the connector 1. The detection unit 101 is in particular set to detect the call setup signal. Once the detection unit 101 has detected such an external signal it will activate the connection unit 103 of the connector 1. The detection unit 101 will also activate interruption unit 104. Regardless of whether the switching unit 106 is set to transmit the signals to the socket 13 or the FM transmitter 105, the signals from the music player 3 will not be forwarded to the respective unit. At this point a ring tone may be output from the connector 1 to the headset 2 or the FM transmitter 105.

Once activated, the communication unit 103 will set up a communication connection, in particular a Bluetooth connection with mobile phone 4. The pairing of the connector 1 to the mobile phone 4 will be established based upon settings within the connector 1, i.e. a preselected mobile phone 4 will be paired with the connector 1.

The status of the connection from the connector 1 to the mobile phone 4 will be indicated to the user by means of the indicator 19. If there is no connection to the mobile phone 4, the indicator 19, which may be a light, will be turned off. During the setting up of the connection, i.e. the pairing, the light of display 19 may blink. Once the mobile phone 4 is connected, the light will be on continuously.

Once the mobile phone 4 is connected to the connector 1 via Bluetooth, the connector 1 may determine the status of the mobile phone 4, in particular whether there is indeed an incoming call at the preselected mobile phone 4. If there is an incoming call at the mobile phone 4, the communication unit 103 will activate the buttons 14, 15 for user input. At this point the user can decide if he wishes to accept or reject the call.

If the detection unit 101 did not activate the interruption unit 104 at the time of activation of the communication unit 103, the communication unit 103 may activate the interruption unit 104 at the point where a connection to the mobile phone 4 has been set up and the existence of an incoming call potentially has been verified. At the latest at this point, the user will be alerted that there is an incoming phone call on his mobile phone 4.

If the user accepts the call, by pressing the accept button 15, the microphone 18 will be activated by the communication unit 103 or by the accept button 15 directly.

At this point, the user can have a telephone conversation via the mobile phone 4, using the headset 2, which he previously was using for listening to music, to listen to the other party and using the microphone 18 of the connector 1 to talk to the other party.

If the FM transmitter 105 had been used before for listening to music, the audio signals received from the mobile phone 4 will be transmitted to the FM transmitter 105 and ultimately to the FM receiver 6. The headset 2 will not be plugged into the connector 1 at this point. The user can then use the speakers of the FM receiver to listen to the other party of the telephone call and can use the microphone 18 for talking to the other party.

If the user is notified by the connector 1 of an incoming call at the mobile phone 4 for example by interrupting the music transmission to the FM receiver 6 and/or by a ring tone output by the connector via the FM receiver 6, the user may decide to switch to a different output mode. In particular, the user may wish to receive the phone call via the headset 2. In this case the user may insert the plug of the headset 2 into the socket 13 of the connector 1. At this point, the connector 1 will intercept the transmission of signals to the FM transmitter 105 by switching switching unit 106 to transmit signals to the socket 13 and thereby to the headset 2 instead.

If the user wishes to terminate the call, he can use the reject button 14, which will terminate the phone call and will also terminate the Bluetooth connection from the mobile phone 4 to the connector 1. The communication unit 103 will become inactive again and will thus not consume power. If the communication unit 103 is inactivated, the interruption unit 104 will be inactivated as well and the user can listen to the music from the music player again 3. Alternatively, the communication unit 103 may be turned off by the detection unit 101 if no more external signals indicating an ongoing telephone conversation, are detected.

In order to avoid interruptions of the user caused by mobile phones in the vicinity, the connector 1 has an adjustment button 102 for adjusting the sensitivity of the detection unit 101. By lowering the sensitivity, only signals from a mobile phone 4, which is in the immediate vicinity of the user, will be detected. As the requirements to the sensitivity of the detection unit 103 will change according to the circumstances such as the number of people close by, the expectation of an incoming phone call etc., the current setting of the sensitivity level will be indicated to the user by means of the display 17. If all three of the LED's of the displays 17 are illuminated, the sensitivity will be set to high and the detection unit 101 will detect signals, even if they originate from a mobile phone which is further away.

Another way to avoid disturbance of the user by phone calls intended for mobile phones other than his own, is by only interrupting the transmission of signals from the rendering device 3 to the head set 2 once the communication unit 103 has confirmed the incoming call at the preselected mobile phone 4.

According to the present invention, it is also possible that the detection unit 101 will detect signalling of the mobile phone 4 for setting up or initiating a phone call. Also in this case, the detection unit 101 or the communication unit 103 may interrupt signal transmission to the headset 2 or the FM receiver 6 from the music player 3.

In a different embodiment of the invention, the switching unit 106 is not activated by the insertion of a plug into the socket 13 of the connector 1, but by identifying the origin of the signals to be output. In this case, the interruption unit 104 may be connected to the switching unit 106 so that once the signals from the music player 3 are interrupted the switching unit 106 will switch from the FM transmitter 105 to the socket 13 automatically.

The present invention is not limited to the depicted embodiment. Single units or parts of the connector, such as for example the adjustment unit and the adjustment button or the display, may be omitted or may be included in other units of the connector. Different lay-outs of the connector can be used. Also the units within the connector as shown in FIG. 2 can be laid out differently and may in particular be partially combined. Also additional units may be provided. Such a unit may for example be a filter. The filter may be used to filter detected signals according to a threshold of the signal strength and/or to filter a preset signal sequence out of a number of signals detected. The latter filter may be used to detected signal frequencies in advanced communication networks such as 3G or 4G networks.

The connector may also be used for other rendering devices than the depicted digital music player. For example a TV or a stereo system can be connected to loud speakers with the connector being interposed in the connection.

The units of the connector are realized as hardware and/or software units.

As described in detail above, a preferred embodiment of the connector according to the present invention comprises an interruption unit, a Bluetooth unit, a detection unit and an FM transmitter. When a mobile device receives an incoming call or sets up a call, this is detected by the detection unit. The interruption unit will interrupt audio from the digital music player, the connector will switch on the Bluetooth unit which will then automatically pair the mobile device via a Bluetooth link. As soon as the connector is connected to a digital music device, via the connector and there is no cable of a headset connected to the connector, the audio of the broadcast on a FM frequency. Any FM radio is then able to receive the forwarded audio from the mobile device. As soon as the detection unit no longer receives GSM signalling traffic from the mobile device, it will switch off the Bluetooth unit and let through the audio signal again from the digital music player or any other audio producing device the connector can connect to.

The present invention, hence, provides the advantages of providing one single device that connects both a digital music player as well as mobile phone to a radio via a built-in FM transmitter. Also the power consumption may be minimized as the consuming Bluetooth module is automatically switched on and off to safe energy for incoming and outgoing calls. Finally, the FM transmitter may be switched off as soon as wired headset is plugged in with a standard audio jack into the connector.

### REFERENCE NUMBERS

1 Connector
11 Cable
111 Plug
12 Casing
13 Socket/Receiving means
14 Reject button
15 Accept button
16 Adjustment button
17 Sensitivity Display
18 Microphone
19 Indicator Bluetooth connection
2 Headset
21 Cable
3 Digital music player
31 Socket/Receiving means
4 Mobile phone
41 Bluetooth connection
5 Base station
6 FM receiver
101 Detection unit
102 Adjustment unit
103 Communication unit
104 Interruption unit
105 FM transmitter
106 Switching unit

1. Connector for connecting a rendering device (3) to at least one output device (2), characterized in that the connector (1) has at least two output interfaces (13, 105), wherein one output interface (105) is a signal transmitter for transmitting signals via radio frequencies.

2. Connector according to claim 1, characterized in that the connector (1) comprises at least one communication unit (103) for communicating with at least one wireless communication device (4) wirelessly, in particular a Bluetooth unit.

3. Connector according to claim 1, characterized in that the connector (1) comprises at least one switching unit (106) for switching from a first output interface (13, 105) to a second output interface (105, 13).

4. Connector according to claim 3, characterized in that the connector (1) comprises a surveillance unit for surveying the availability of an output device (4, 6) at the output interface (13, 105).

5. Connector according to claim 4, characterized in that the surveillance unit is connected to the switching unit (106).

6. Connector according to claim 3, characterized in that the switching unit (106) is connected to a determination unit for determining the input source of signals to be routed through the switching unit (106).

7. Connector according to claim 1, characterized in that it comprises at least one detection unit (101) for detecting at least one external signal.

8. Connector according to claim 7, characterized in that the detection unit (101) is connected to a communication unit (103) for managing the communication unit (103).

9. Connector according to claim 1, characterized in that the connector (1) comprises at least one interruption unit (104) for managing the connection of the rendering device (3) to the output device (2).

10. Connector according to claim 9, characterized in that a communication unit (103) is connected to the interruption unit (104).

11. Connector according to claim 1, characterized in that the connector (1) comprises a microphone (18) for input of audio signals.

12. Connector according to claim 11, characterized in that the microphone (18) is connected to a control unit (14, 15) of the connector (1).

13. Method for managing output from at least one rendering and/or a communication device (3, 4), wherein a connector (1) for connecting the rendering and/or communication device (3, 4) to at least one output device (2) is interposed between the rendering device and/or communication device (3, 4) and the at least one output device (2, 6), characterized in that the connector (1) receives audio and/or video signals from at least one rendering or communication device (3, 4) and transmits the received signal to one of at least two output interfaces (13, 105) of the connector (1) depending on the state of the output interfaces (13, 105) and/or on the nature of the received signals.

14. Method according to claim 13, characterized in that the connector intercepts transmission to an output interface (13, 105) upon detection of availability of an output device (3, 4) at a different output interface (13, 105).

15. Method according to claim 13, characterized in that at least one output interface (13, 105) is an interface (105) for transmission via radio frequencies and at least one output interface (13, 105) is an interface (13) for transmission via a wired connection, wherein the transmission via the wired connection is given preference over the transmission via radio frequencies.

16. Method according to claim 13, characterized in that the connector (1) identifies the origin of the received signals and transmits the signals to a predetermined output interface (13, 105).

17. Method according to claim 13, characterized in that upon detection of a specific external signal which was detected wirelessly the connector (1) activates a communication unit (103) of the connector (1) for communication with the communication device (4).

18. Method according to claim 13, characterized in that the transmission of signals from a rendering device (3) to an output device (2) is interrupted upon detection of an external signal at the connector (1).

19. Method according to claim 13, characterized in that it employs a connector (1).

20. Connector according to claim 1, characterized in that the connector (1) comprises a surveillance unit for surveying the availability of an output device (4, 6) at the output interface (13, 105).

21. Connector according to claim 3, characterized in that it comprises at least one detection unit (101) for detecting at least one external signal.

22. Connector according to claim 3, characterized in that the connector (1) comprises at least one interruption unit (104) for managing the connection of the rendering device (3) to the output device (2).

23. Method according to claim 14, characterized in that at least one output interface (13, 105) is an interface (105) for transmission via radio frequencies and at least one output interface (13, 105) is an interface (13) for transmission via a wired connection, wherein the transmission via the wired connection is given preference over the transmission via radio frequencies.

24. Method according to claim 14, characterized in that it employs a connector (1).
